(19) United States
(12) Patent Application Publication
(10) Pub. No.: US 2005/0112967 A1
(43) Pub. Date: May 26, 2005

(54) Bladder made from flame-resistant fabric and from fluid-impervious film

(76) Inventors: William L. Grilliot, Dayton, OH (US); Mary I. Grilliot, Dayton, OH (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 10/718,276

(22) Filed: Nov. 20, 2003

(51) Int. Cl. B32B 27/12

(52) U.S. Cl. 442/59; 442/286; 428/34.1

(57) ABSTRACT

An inflatable bladder is made from a fluid-impervious film providing a liner for the bladder and from a flame-resistant fabric providing a cover for the bladder. The bladder is made from two sheets, in each of which the fluid-impervious film and the flame-resistant fabric are laminated to each other. The fluid-impervious film of one such sheet is bonded to the fluid-impervious film of the other sheet, along what becomes an outer edge of the bladder. The bladder may be then inflated with a gas, with a liquid, or with a gel.

### TECHNICAL FIELD OF THE INVENTION

This invention pertains to bladder, which is inflatable or inflated with a suitable fluid, such as a gas, liquid, or gel. This invention contemplates that the bladder has a flame-resistant cover, so as to be particularly suitable for a previously disclosed application in a protective garment for a firefighter or for an emergency worker and to be potentially suitable for a wide range of similar and dissimilar applications.

### BACKGROUND OF THE INVENTION

As disclosed in U.S. patent application Ser. No. 10/443,640, which was filed on May 22, 2003, and the disclosure of which is incorporated by reference herein, a protective garment for a firefighter or for an emergency worker is provided with a shoulder pad, which is to be worn between the protective coat and a shoulder of a wearer. The shoulder pad is attached detachably, as by a hook-and-loop fastener, to a shoulder strap of suspenders worn by the wearer or to the protective coat. The shoulder pad contains a bladder, which is adapted to be inflated with a suitable fluid, such as a gas, liquid, or gel, so to increase an air space between the protective coat and the shoulder of the wearer. The air space provides thermal insulation between the protective coat and the shoulder of the wearer.

### SUMMARY OF THE INVENTION

This invention provides an improved bladder, which can be advantageously provided in a protective garment for a firefighter or for an emergency worker, as discussed above, and which may be potentially suitable for a wide range of similar and dissimilar applications. Basically, the improved bladder is made from a fluid-impervious film providing a liner for the bladder and from a flame-resistant fabric providing a cover for the bladder, which is inflatable or inflated with a suitable fluid, such as a gas, liquid, or gel. Preferably, the fluid-impervious film is laminated to the flame-resistant fabric.

In a preferred embodiment, the bladder comprises two sheets, each comprising the fluid-impervious film and the flame-resistant fabric, which is laminated to the fluid-impervious film. In the preferred embodiment, one said sheet is bonded adhesively, by heat-sealing, or otherwise to the other sheet, along what becomes an outer edge of the bladder.

### BRIEF DESCRIPTION OF THE DRAWINGS

FIG. 1 is a perspective view of an improved bladder embodying this invention.

FIG. 2, on a larger scale, is a sectional view, which is taken along line 2-2 of FIG. 1, in a direction indicated by arrows.

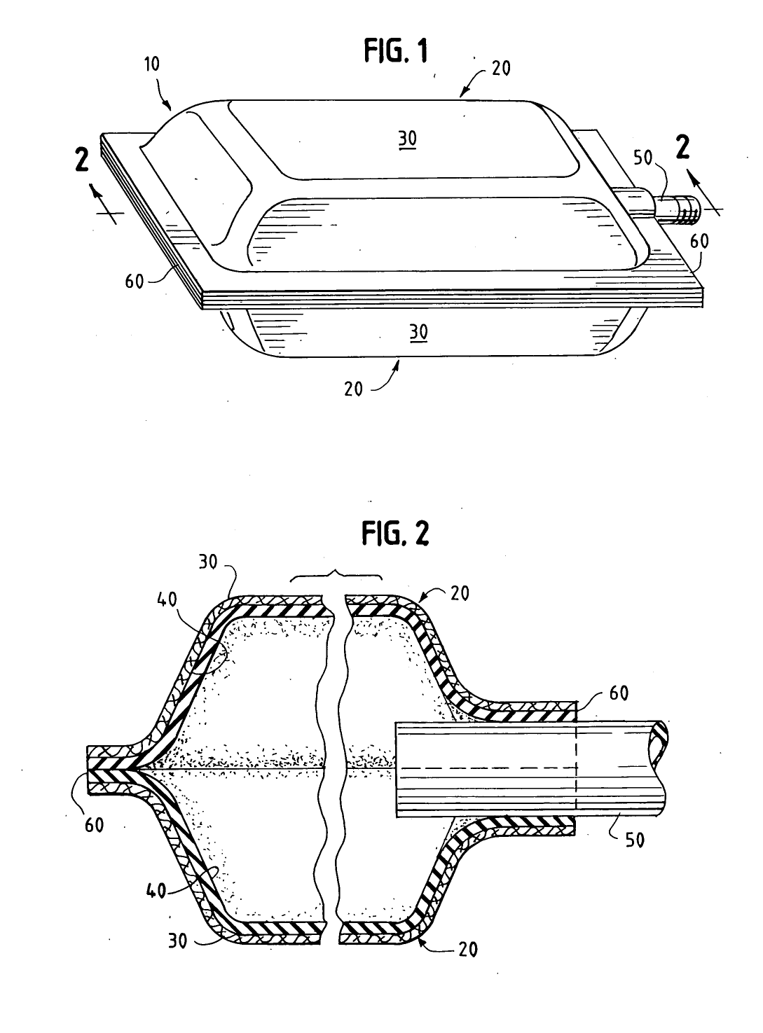

### DETAILED DESCRIPTION OF THE ILLUSTRATED EMBODIMENT

As illustrated, an inflatable bladder 10 embodying this invention is made from two sheets 20 of a composite material, which has an outer layer 30 and an inner layer 40. The outer layer 30 is made from a flame-resistant, woven fabric, which is woven from a suitable fiber, such as Nomex™ fiber, which is available commercially from E.I. Dupont de Nemours and Company, Wilmington, Del. The inner layer 40 is made from a fluid-impervious, polymeric film, such as a synthetic rubber, which can be adhesively sealed to itself, heat-sealed to itself, or bonded otherwise to itself, so as to be fluid-impervious where bonded to itself. Preferably, as illustrated, the outer layer 30 and the inner layer 40 are laminated to each other.

The sheets 20 are oriented so that the inner layers 40 of the sheets 20 face each other, whereupon an inflating valve 50, which is conventional, is inserted between the inner layers 40 of the sheets 20. After the inflating valve 50 has been inserted therebetween, the inner layers 40 of the sheets 20 are bonded to each other, by being adhesively sealed or, if feasible, by being heat-sealed, so as to be fluid-impervious where bonded to each other, along what becomes an outer edge 60 of the resultant bladder 10. If the outer layer 30 of each sheet 20 and the inner layer 40 of said sheet 20 are not laminated to each other, the respective layers 30, 40, are bound to one another, as by sewing, along the outer edge 60 of the resultant bladder 10. The resultant bladder 10 can be then inflated, via the inflating valve 50, with a gas, such as air, with a liquid, such as water, or with a gel.

Because the flame-resistant fabric of the outer layers 40 of the sheets 20 covers the resultant bladder 10, which is lined by the fluid-impervious film of the inner layers 30 of the sheets 20, the resultant bladder can be advantageously used in a protective garment for a firefighter or for an emergency worker, as disclosed in U.S. patent application Ser. No. 10/443,640, supra. Moreover, the resultant bladder 10 is expected to be potentially suitable for a wide range of similar and dissimilar applications.

1. An inflatable bladder made from a fluid-impervious film providing a liner for the bladder and from a flame-resistant fabric providing a cover for the bladder.

2. The inflatable bladder of claim 1, wherein the fluid-impervious film and the flame-resistant fabric are laminated to each other.

3. The inflatable bladder of claim 2, which comprises two sheets bonded to each other, along what becomes an outer edge of the inflatable bladder, each sheet being made from the fluid-impervious film and from the flame-resistant fabric laminated to the fluid-impervious film.

4. The inflatable bladder of claim 3, wherein the fluid-impervious film of one said sheet is bonded to the fluid-impervious film of the other sheet, along what becomes an outer edge of the bladder.

5. The inflatable bladder of claim 1, 2, 3, or 4, after being inflated with a gas, with a liquid, or with a gel.
